(19) United States
(12) Patent Application Publication
(10) Pub. No.: US 2012/0257922 A1
(43) Pub. Date: Oct. 11, 2012

(54) PIVOT PIN STRUCTURE

(75) Inventors: CHANG YU LIN, NEW TAIPEI CITY (TW); CHIEN CHENG MAI, TAIPEI COUNTY (TW)

(73) Assignee: FIRST DOME CORPORATION, TAIPEI COUNTY 242 (TW)

(21) Appl. No.: 13/081,603

(22) Filed: Apr. 7, 2011

(51) Int. Cl. F16C 11/04

(52) U.S. Cl. 403/161

(57) ABSTRACT

A pivot pin structure includes an assembling section formed on a surface of the pivot pin for assembling with at least one bridge member. The bridge member has a pivot section, which rotatably encloses the assembling section of the pivot pin. On the assembling section are disposed multiple ridge sections and valley sections non-parallel to the axis of the pivot pin. The ridge sections and valley sections are formed in a cross-sectional direction of the pivot pin normal to or approximately normal to the axis of the pivot pin and continuously arranged on the surface thereof. By means of the ridge sections and valley sections of the assembling section, the pivot pin can be assembled with the bridge member in an interference-fit manner to naturally provide a guide and restriction effect and lubricant-reserving effect. Therefore, the bridge member is restricted to only rotate around the pivot pin without axially displacing.

### BACKGROUND OF THE INVENTION

1. Field of the Invention

The present invention relates generally to an enclosure-type pivot pin structure applied to a display screen of an electronic device, and more particularly to a pivot pin with simplified structure. The pivot pin can be easily assembled with a bridge member in an interference-fit manner to naturally provide a guide and restriction effect and lubricant-reserving effect. Therefore, the bridge member is restricted to only rotate around the pivot pin without axially displacing.

2. Description of the Related Art

Various conventional pivot pin structures have been developed and applied to rotatable covers or display screens of electronic devices such as cellular phones, laptop computers and digital cameras. For example, FIG. 1 shows an assembly of a conventional pivot pin 10 and bridge member 20.

As shown in FIG. 1, the pivot pin 10 has the form of a pole body, including a pivot section 11 with a polished surface for assembling with the bridge member 20. The bridge member 20 has the form of a board body. The bridge member 20 is mounted on a cover or a display screen. One end of the bridge member 20 is formed with a bight section (or pivot section) 21. The bight section 21 can be axially fitted onto the pivot section 11 of the pivot pin 10 in an interference-fit manner. When an operator rotates the cover or the display screen, the bight section 21 of the bridge member 20 is forcedly rotated around the pivot section 11 of the pivot pin 10.

In practice, in order to hinder the bight section 21 from axially displacing along the pivot section 11 in operation of the display screen, a C-shaped retainer ring 15 is mounted at the end of the pivot pin 10 to help in fixing the bight section 21 with the pivot section 11 and prevent the bight section 21 from axially detaching from the end of the pivot pin 10. Also, in order to minimize the wear of the bight section 21 and the pivot section 11 in rotational operation, a lubricant is applied between the bight section 21 and the pivot section 11. In addition, the pivot pin 10 has an embossed section 12 for fixedly assembling with another bridge member 25 mounted on the case of the electronic device.

The conventional pivot pin 10 has some shortcomings in practical operation as follows:
1. It is necessary to additionally mount the C-shaped retainer ring 15 on the pivot pin 10 to prevent the bight section 21 of the bridge member 20 from axially displacing. This complicates the assembling process of the pivot pin 10 and the bridge member 20. Also, the structure of the pivot pin as a whole becomes more complicated. The leads to increase of manufacturing cost.
2. In order to tightly and fully assemble the pivot section 11 with the bight section 21 in an interference-fit manner, it is necessary to process the entire surface of the pivot section 11 and the bight section 21 at very high precision. This increases difficulty in the processing operation. In other words, it is hard to control the processing precision of the pivot section 11 and the bight section 21 for fully tight interference fit thereof. Moreover, in case the pivot section 11 is interference-fitted in the bight section 21 along a non-uniform contact line or on a non-uniform contact face, it will be hard to smoothly rotate the bight section 21 around the pivot section 11. This will also lead to uneven wear of the components.
3. When pressing the bridge member 25 onto the embossed section 12 of the pivot pin to directly fix the bridge member 25 with the embossed section 12, iron or metal chips are produced under the thrust force between the bridge member 25 and the embossed section 12. It is necessary to clean up the metal chips to avoid affection of the metal chips on the connection between the pivot pin 10 and the bridge member 25.
4. In torque test for assembly of the pivot pin 10 and the bridge member 20, a tool is used to clamp the pivot pin 10 for performing the torque test. After clamped by the tool, clear tool marks are often left on the surface of the pivot pin 10 to ruin the appearance of the pivot pin 10.
5. The pivot section 11 and the bight section 21 are tightly assembled with each other in an interference-fit manner. Therefore, when rotating the bight section 21 around the pivot section 11, the lubricant applied between the pivot section 11 and the bight section 21 is often squeezed and spilled out. This will deteriorate the smoothness of rotation between the pivot pin 10 and the bridge member 20.

It is therefore tried by the applicant to provide an improved pivot pin structure to overcome the above problems existing in the prior art. The pivot pin structure is free from any additional locating member such as C-shaped retainer ring for preventing the bridge member from axially displacing. Accordingly, the pivot pin can be more easily assembled with the bridge member in a uniform interference-fit manner.

### SUMMARY OF THE INVENTION

It is therefore a primary object of the present invention to provide an improved pivot pin structure including an assembling section formed on a surface of the pivot pin for assembling with at least one bridge member. The bridge member has a pivot section, which rotatably encloses the assembling section of the pivot pin. On the assembling section are disposed multiple ridge sections (or raised sections) and valley sections (or recessed sections) non-parallel to the axis of the pivot pin. The ridge sections and valley sections are formed in a cross-sectional direction of the pivot pin normal to or approximately normal to the axis of the pivot pin and continuously arranged on the surface thereof. By means of the ridge sections and valley sections of the assembling section, the pivot pin can be assembled with the bridge member in an interference-fit manner to naturally provide a guide and restriction effect and lubricant-reserving effect. Therefore, the bridge member is restricted to only rotate around the pivot pin without axially displacing.

It is a further object of the present invention to provide the above pivot pin structure in which the ridge sections or valley sections are formed on the pivot pin in different cross-sectional positions. Accordingly, the ridge sections are disposed on the surface of the pivot pin around the axis thereof as a thread structure. The ridge sections provide a directional guide system for restricting the bridge member to reciprocally rotate only in the direction of the ridge sections.

It is still a further object of the present invention to provide the above pivot pin structure in which the ridge sections (or raised sections) are continuously or discontinuously arranged on the surface of the pivot pin.

It is still a further object of the present invention to provide the above pivot pin structure, which has an embossed section and a depression positioned near the embossed section. When pressing the bridge member onto the embossed section of the pivot pin in an interference-fit manner, the metal chips produced under the thrust force between the bridge member and the embossed section are pushed into the depression. The metal chips are received in the depression so that it is unnecessary to further clean up the metal chips as in the prior art. Moreover, the depression also provides an area for a tool to clamp in torque test for assembly of the pivot pin and the bridge member. Therefore, after the embossed section of the pivot pin is assembled with the bridge member affixed to the case of the electronic device, the depression and the clamp marks formed on the depression are all concealed by the bridge member. This solves the problem of ruin of the appearance of the pivot pin due to the tool marks.

The present invention can be best understood through the following description and accompanying drawings, wherein:

### BRIEF DESCRIPTION OF THE DRAWINGS

FIG. 1 is a perspective assembled view of an assembly of a conventional pivot pin and bridge member;

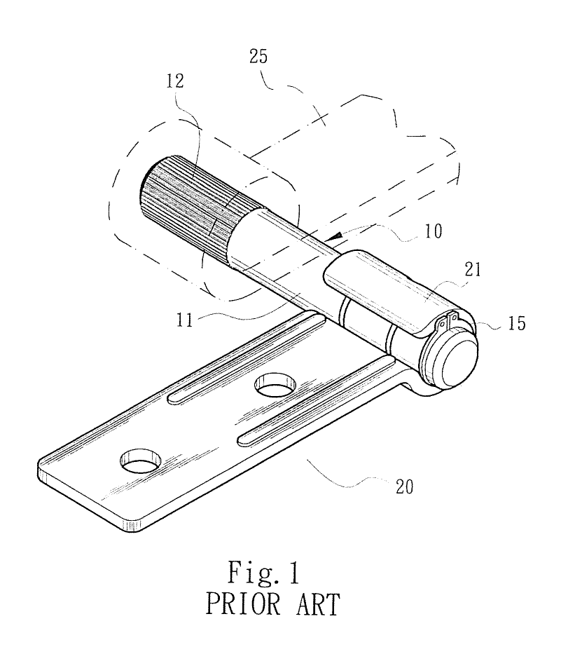

FIG. 2 is a perspective assembled view of the assembly of the pivot pin and bridge member of the present invention;

FIG. 3 is a perspective exploded view of the present invention;

FIG. 4 is a sectional assembled view of the assembly of the pivot pin and bridge member of the present invention;

FIG. 5 is a perspective view showing that the pivot pin and bridge member of the present invention are mounted on an electronic device; and

FIG. 6 is a perspective view of another embodiment of the pivot pin of the present invention, in which the ridge sections are discontinuously arranged on the assembling section of pivot pin.

### DETAILED DESCRIPTION OF THE PREFERRED EMBODIMENTS

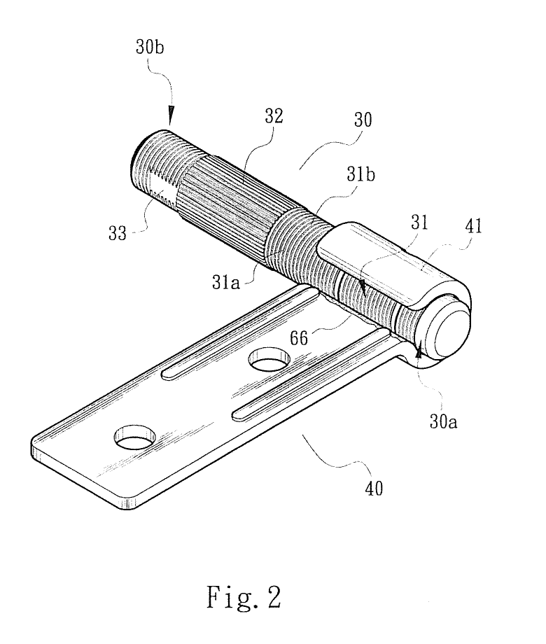

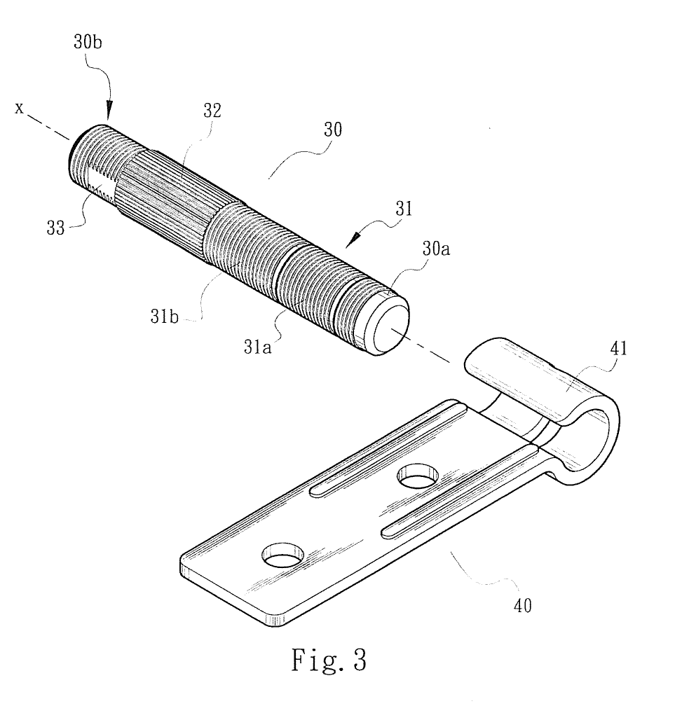

Please refer to FIGS. 2 and 3. The pivot pin structure of the present invention includes a pivot pin 30 and a bridge member 40 assembled with the pivot pin 30. The pivot pin 30 has the form of a pole body. The pivot pin 30 has an axis χ and an assembling section 31 for assembling with the bridge member 40. The pivot pin 30 further has an embossed section 32 adjacent to the assembling section 31.

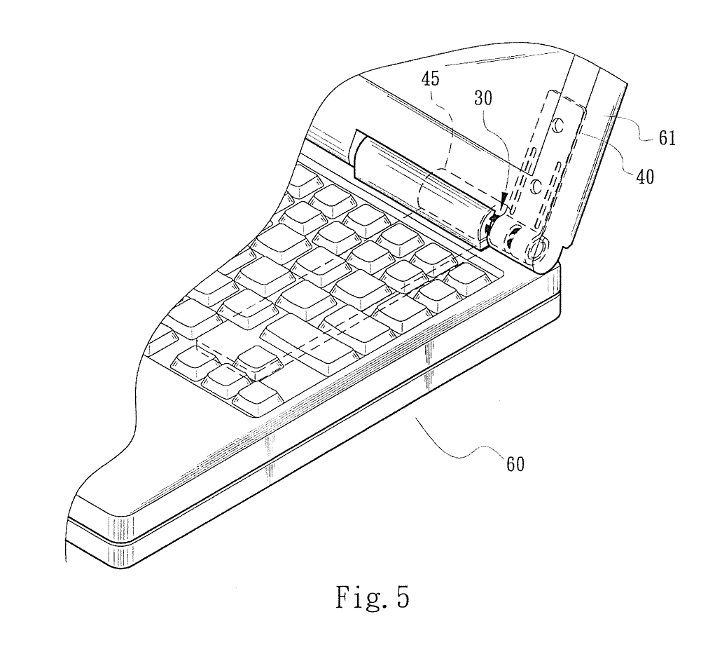

In a preferred embodiment, the bridge member 40 is fixedly mounted on a cover or display screen 61 of an electronic device 60 (as shown in FIG. 5). The bridge member 40 has the form of a board body, having a pivot section (or bight section) 41 in which the assembling section 31 of the pivot pin 30 is enclosed.

In the preferred embodiment of the present invention, the assembling section 31 is formed with multiple ridge sections (or raised sections) 31a and valley sections (or recessed sections) 31b non-parallel to the axis χ. Preferably, the ridge sections 31a and valley sections 31b are formed in a cross-sectional direction of the pivot pin 30 normal to or approximately normal to the axis χ of the pivot pin 30 and continuously arranged on a surface of the pivot pin 30. Therefore, when the display screen 61 is operated to reciprocally rotate, the bridge member 40 is only allowed to rotate around the pivot pin 30 without axially displacing. To speak more specifically, the ridge sections 31a serve as a directional guide system for restricting the bridge member 40 or pivot section 41 to reciprocally rotate only in the direction of the ridge sections 31a and providing a restriction (locating) effect. In a preferred embodiment, each ridge section 31a (or valley section 31b) is formed as an independent annular raised (or recessed) stripe in parallel to the other.

In a modified embodiment, the ridge sections 31a (or valley sections 31b) are formed on the pivot pin 30 in different cross-sectional positions. That is, the ridge sections 31a (or valley sections 31b) are disposed on the surface of the pivot pin 30 around the axis χ as a thread structure to reinforce the directional guide system. In this case, the bridge member 40 or pivot section 41 is more securely restricted to reciprocally rotate only in the direction of the ridge sections 31a.

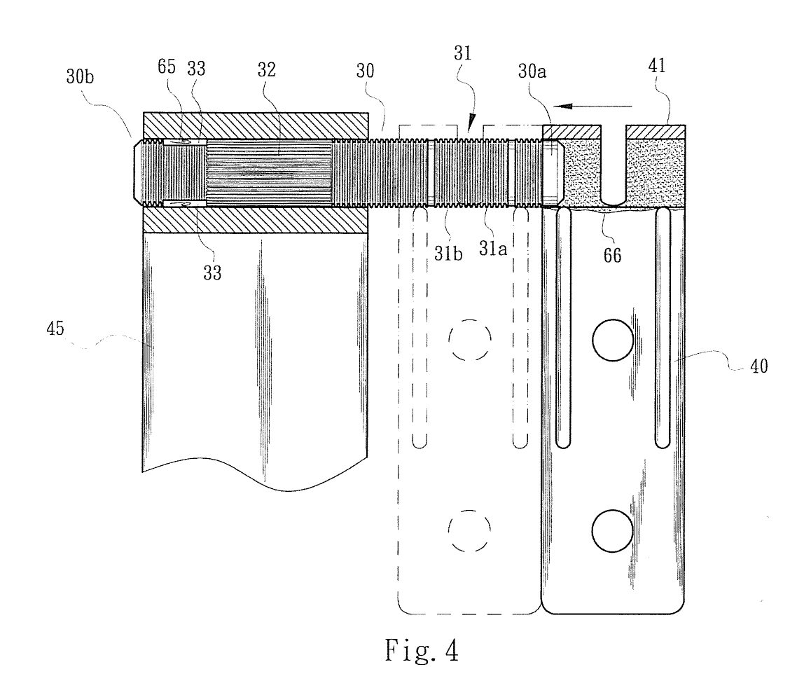

Please refer to FIGS. 3 and 4. In a preferred embodiment, the pivot pin 30 defined with a first end 30a and a second end 30b. The first end 30a is adjacent to or positioned on the assembling section 31. The second end 30b is adjacent to or positioned on the embossed section 32 of the pivot pin 30. The first end 30a has a cross-sectional width (or diameter) slightly smaller than that of the assembling section 31. Therefore, there is a height difference or cross-sectional width difference between the first end 30a and the assembling section 31. When an operator assembles the pivot pin 30 with the bridge member 40 in an interference-fit manner, the height difference provides an aim and guide effect.

To speak more specifically, the diameter of cross-sectional width of the first end 30a is smaller so that the pivot pin 30 is easier to be aimed at and fitted into the pivot section 41 of the bridge member 40. Moreover, under the guide of the first end 30a, the assembling section 31 can be more easily assembled with the pivot section 41 of the bridge member 40 in an interference-fit manner.

Please refer to FIG. 4, which shows the assembling process of the pivot pin 30 with the bridge members 40, 45. The embossed section 32 of the pivot pin 30 is fixedly assembled with the bridge member 45, whereby the bridge member 45 is hindered from rotating around the pivot pin 30. FIG. 5 shows that the bridge member 45 is mounted on the electronic device (or computer case) 60.

In a preferred embodiment, at least one depression 33 is formed at the second end 30b of the pivot pin 30 in adjacency to the embossed section 32 opposite to the assembling section 31. As shown in the drawings, the depression 33 has the form of a dent with a plane face 33a. The plane face 33a has a cross-sectional height lower than that of the outer surface of the pivot pin 30. Accordingly, when fitting the embossed section 32 of the pivot pin 30 into the bridge member 45 in a interference-fit manner, the metal chips 65 produced under the thrust force between the embossed section 32 and the bridge member 45 are pushed into the depression 33. The metal chips 65 are received in the depression 33 so that it is unnecessary to further clean up the metal chips as in the prior art. Preferably, the depression 33 is symmetrically positioned on the pivot pin 30.

It should be noted that the depression 33 also provides an area for a tool to clamp in torque test of the pivot pin 30. Therefore, after the embossed section 32 of the pivot pin 30 is assembled with the bridge member 45 affixed to the electronic device 60 or computer case, the depression 33 and the clamp marks formed on the depression 33 are all concealed by the bridge member 45 as shown in FIG. 4. This solves the problem of ruin of the appearance of the pivot pin due to the tool marks.

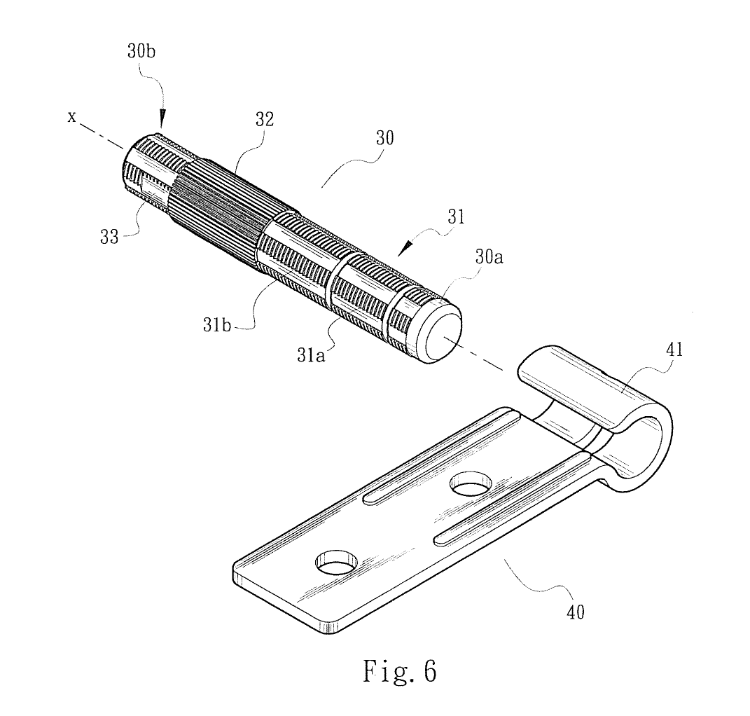

Please refer to FIG. 6. In a modified embodiment, the ridge sections (or raised sections) 31a are continuously or discontinuously disposed on the surface of the assembling section 31. In FIG. 6, it is shown that the ridge sections (or raised sections) 31a are discontinuously (or disconnectedly) disposed on the assembling section 31 segment by segment.

In comparison with the prior art, the pivot pin structure of the present invention has the following advantages:
1. On the assembling section 31 are disposed multiple ridge sections 31a or thread structures non-parallel to the axis χ. The ridge sections 31a are continuously arranged on the assembling section 31 to provide a directional guide system. Accordingly, the bridge member 40 or pivot section 41 is restricted to reciprocally rotate only in the direction of the ridge sections 31a. In contrast, in the prior art, a C-shaped retainer ring 15 must be additionally mounted on the pivot pin to prevent the bridge member 20 from axially displacing.
2. On the assembling section 31 are disposed multiple ridge sections 31a and valley sections 31b non-parallel to the axis χ. The ridge sections 31a and valley sections 31b are continuously arranged on the assembling section 31, whereby the assembling section 31 can be tightly securely assembled with the pivot section 41 in an interference-fit manner. In addition, a guide and restriction effect is achievable by means of the ridge sections 31a and valley sections 31b. The ridge sections 31a and valley sections 31b can be easily formed through an existing processing operation to more easily control the precision of the interference-fit connection. In contrast, in the prior art, a complicated processing operation is needed for tightly assembling the pivot pin 10 with a polished surface with the bridge member 20. Moreover, in the prior art, the pivot pin 10 is often interference-fit ted in the bight section 21 of the bridge member along a non-uniform contact line or on a non-uniform contact face. This will lead to unsmooth rotation and uneven wear of the components. By means of the ridge sections 31a and valley sections 31b of the present invention, such problems are overcome.
3. When assembling the embossed section 32 of the pivot pin with the bridge member 45 in an interference-fit manner, the iron or metal chips 65 produced under the thrust force between the embossed section 32 and the bridge member 45 are pushed into the depression 33. The metal chips 65 are received in the depression 33 so that it is unnecessary to further clean up the metal chips as in the prior art. Moreover, the depression 33 also provides an area for a tool to clamp in torque test for assembly of the pivot pin 30 and the bridge member 40. In contrast, in the prior art, after clamped by a tool, clear tool marks are often left on the surface of the pivot pin 10 to ruin the appearance of the pivot pin 10. By means of the depression 33, this problem is overcome.
4. On the assembling section 31 are disposed multiple valley sections 31b non-parallel to the axis χ. The valley sections 31b are continuously arranged on the assembling section 31, whereby after the assembling section 31 is assembled with the pivot section 41 of the bridge member, the lubricant 66 is reserved in the valley sections 31b between the assembling section 31 and the pivot section 41 as shown in FIG. 2. In contrast, in the prior art, when rotating the bridge member, the lubricant is often squeezed and spilled out. By means of the valley sections 31b of the present invention, this problem is overcome to keep the smoothness of rotation between the pivot pin 30 and the bridge member 40.

The above embodiments are only used to illustrate the present invention, not intended to limit the scope thereof. Many modifications of the above embodiments can be made without departing from the spirit of the present invention.

What is claimed is:

1. A pivot pin structure comprising an axis and an assembling section disposed on a surface of the pivot pin, on the assembling section being disposed multiple ridge sections and valley sections non-parallel to the axis, the ridge sections and valley sections being arranged on the assembling section.

2. The pivot pin structure as claimed in claim 1, wherein the ridge sections and valley sections are formed in a cross-sectional direction of the pivot pin approximately normal to the axis of the pivot pin and continuously arranged on the surface of the pivot pin.

3. The pivot pin structure as claimed in claim 1, wherein the ridge sections are annularly disposed on the surface of the pivot pin in the form of a thread structure.

4. The pivot pin structure as claimed in claim 1, wherein the pivot pin has a first end and a second end, the first end being adjacent to the assembling section, the first end having a cross-sectional width slightly smaller than that of the assembling section.

5. The pivot pin structure as claimed in claim 4, wherein an embossed section is disposed on the pivot pin in adjacency to the second end thereof.

6. The pivot pin structure as claimed in claim 1, wherein the ridge sections are arranged in parallel to each other.

7. The pivot pin structure as claimed in claim 1, wherein at least one depression is formed on the pivot pin.

8. The pivot pin structure as claimed in claim 7, wherein the depression has the form of a dent with a plane face.

9. The pivot pin structure as claimed in claim 8, wherein the plane face of the dent has a height lower than that of outer surface of the pivot pin.

10. The pivot pin structure as claimed in claim 1, wherein an embossed section is disposed on the pivot pin, at least one depression being formed at a second end of the pivot pin in adjacency to the embossed section opposite to the assembling section.

11. The pivot pin structure as claimed in claim 10, wherein the depression has the form of a dent with a plane face.

12. The pivot pin structure as claimed in claim 11, wherein the plane face of the dent has a height lower than that of outer surface of the pivot pin.

13. The pivot pin structure as claimed in claim 7, wherein the depression is symmetrically formed on the pivot pin.

14. The pivot pin structure as claimed in claim 10, wherein the depression is symmetrically formed on the pivot pin.

15. The pivot pin structure as claimed in claim 1, wherein the ridge sections are discontinuously disposed on the assembling section of the pivot pin.

16. The pivot pin structure as claimed in claim 1, wherein the pivot pin has the form of a pole body.

17. The pivot pin structure as claimed in claim 1, wherein the assembling section is assembled with a bridge member in the form of a board body, the bridge member having a pivot section assembled with the assembling section of the pivot pin.

18. The pivot pin structure as claimed in claim 1, wherein an embossed section is disposed on the pivot pin in adjacency to the assembling section.

19. The pivot pin structure as claimed in claim 1, wherein an embossed section is disposed on the pivot pin and assembled with a bridge member.

20. The pivot pin structure as claimed in claim 17, wherein the bridge member is fixedly mounted on a display screen of an electronic device.

21. The pivot pin structure as claimed in claim 19, wherein the bridge member is fixedly mounted on an electronic device.

22. The pivot pin structure as claimed in claim 15, wherein the ridge sections are disconnectedly disposed on the surface of the pivot pin segment by segment.

23. The pivot pin structure as claimed in claim 1, wherein a lubricant is reserved in the valley sections.

24. The pivot pin structure as claimed in claim 1, wherein the ridge sections are continuously arranged on the surface of the pivot pin.

25. The pivot pin structure as claimed in claim 1, wherein the ridge sections and valley sections are formed in a cross-sectional direction of the pivot pin normal to the axis of the pivot pin and continuously arranged on the surface of the pivot pin.

26. The pivot pin structure as claimed in claim 1, wherein the ridge sections are independent annular raised stripes in parallel to each other.

27. The pivot pin structure as claimed in claim 1, wherein the valley sections are independent annular recessed stripes in parallel to each other.
